(19) United States
(12) Patent Application Publication
(10) Pub. No.: US 2016/0300391 A1
(43) Pub. Date: Oct. 13, 2016

(54) SYSTEM AND METHOD FOR REDUCING SIMULATOR SICKNESS

(71) Applicant: Purdue Research Foundation, West Lafayette, IN (US)

(72) Inventors: David Matthew Whittinghill, West Lafayette, IN (US); Bradley Ziegler, Mount Vernon, IN (US); Tristan Case, Fort Wayne, IN (US); Brenan Moore, Nappanee, IN (US)

(21) Appl. No.: 15/093,386

(22) Filed: Apr. 7, 2016

Related U.S. Application Data
(60) Provisional application No. 62/144,309, filed on Apr. 7, 2015.

(51) Int. Cl. G06T 19/00

(52) U.S. Cl. CPC G06T 19/006

(57) ABSTRACT

A system and method for reducing simulator sickness is provided. The system displays a simulated moving environment to a user in addition to a simulated fixed object in the view of the user. In one example, the fixed object is a human nose. The interface module may be implemented as a head-mounted electronic display.

### RELATED APPLICATIONS

The present application is related to and claims the priority benefit of U.S. Provisional Patent Application Ser. No. 62/144309, filed Apr. 7, 2015, the contents of which is hereby incorporated by reference in its entirety into the present disclosure.

### TECHNICAL FIELD

The present application relates to simulator systems, and more specifically, simulator systems used in gaming or other virtual reality applications.

### BACKGROUND

Motion sickness (MS) is a physiological phenomena that dates back to the days of antiquity. Ever since humans devised means of locomotion that exceeded the limits imposed by normal walking, running, and jumping motion sickness has been a nuisance for many travelers. Phenomena such as “sea sickness”, “air sickness” and the illness some individuals feel during amusement rides are all manifestations of MS. Modern technology has brought about a new, closely-related condition called simulator sickness (SS). One of the earliest recorded observations of SS was in the 1950's when helicopter pilots testing early flight simulators reported experiencing the cardinal symptoms of MS, nausea and emesis (sweating, pallor, vomiting) despite the pilots not actually moving. Even more modern virtual reality and simulator systems continue to suffer from the simulator sickness phenomena. Therefore, improvements are needed in the field.

### SUMMARY

The present disclosure provides a system and method for reducing simulator sickness by placing a virtual fixed reference object within a user's field of view that roughly approximates the position and proportion of the nose. The object may be, in fact, a nose, or other body part. The reference object may be displayed from a perspective from which the user would view it in real life, such as the user's own nose. Additional fixed objects may also be used and are contemplated to be within the scope of the present disclosure. The system and method may be employed to provide a simulation of an environment, such as in a virtual reality game, or training simulation, such as a vehicle or experience simulator. The object of agency (player avatar) within the simulation or game may or may not be human.

According to various aspects, the object may be displayed laterally centered in the field of view of the user. The display may be provided as part of a head-mounted unit. In addition, the display may comprise a left eye display and a right eye display, wherein the left eye display displays a left portion of the object and the right eye display displays a right portion of the object to the user. The object may also be shaded to simulate real-world lighting of the object.

### BRIEF DESCRIPTION OF THE DRAWINGS

In the following description and drawings, identical reference numerals have been used, where possible, to designate identical features that are common to the drawings.

FIG. 1 shows a simulator display view sent to a user's left and right eye, respectively.

FIG. 2 shows a user using the system of FIG. 3.

FIG. 3 is a diagram showing the components of an example virtual reality simulator data-processing system.

The attached drawings are for purposes of illustration and are not necessarily to scale.

### DETAILED DESCRIPTION

Throughout this description, some aspects are described in terms that would ordinarily be implemented as software programs. Those skilled in the art will readily recognize that the equivalent of such software can also be constructed in hardware, firmware, or micro-code. Because data-manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

Steps of various methods described herein can be performed in any order except when otherwise specified, or when data from an earlier step is used in a later step. Exemplary method(s) described herein are not limited to being carried out by components particularly identified in discussions of those methods.

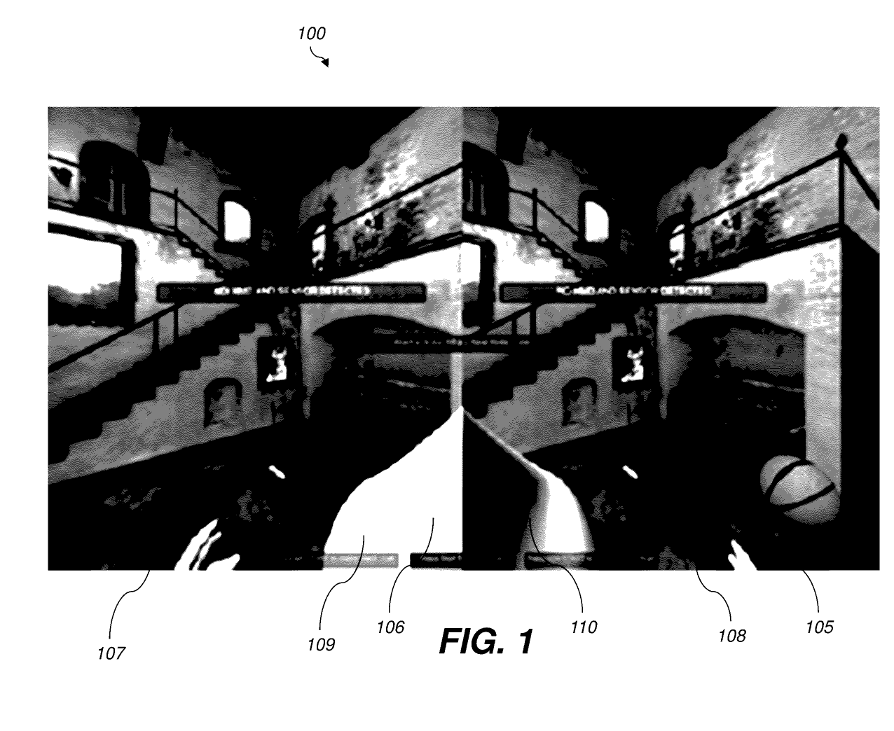

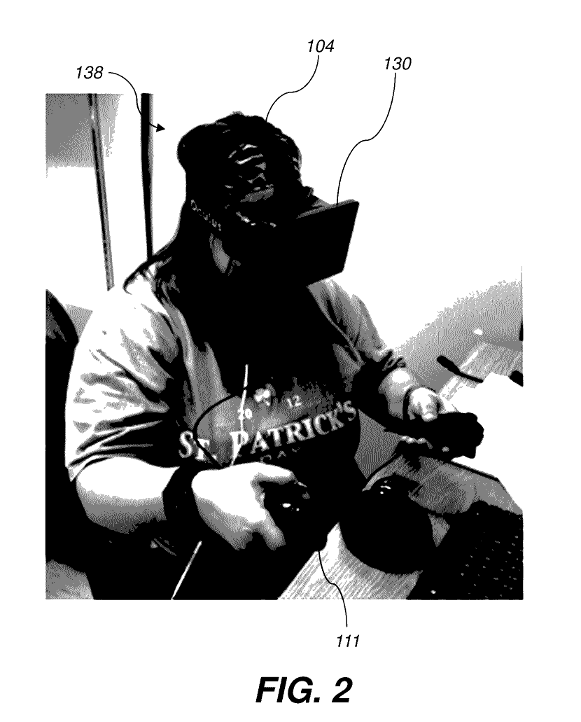

FIG. 1 shows an example of a virtual-reality simulation 100, as viewed by a user 138. In certain embodiments, the simulation is displayed to the user 138 by an electronic display 102 as part of a head-mounted unit 104 as shown in FIG. 2. The simulation view includes moving environment 105. Various types of moving environments may be displayed, such as those used in games or aviation flight training simulations. In order to reduce simulator sickness of the user, a virtual fixed reference object 106 is displayed within the user's field of view as shown. In other words, the reference object remains fixed in the user's field of while the moving environment changes to simulate the user's movement within the environment. In certain embodiments, the object is laterally centered within the user's field of view as shown in FIG. 1. The object may be, for example, a simulated human nose as shown in FIG. 1. However, other objects may also be used.

In certain embodiments, the electronic display 102 may comprise a separate left display (107) and right display (108), for the left and right eyes of the user, respectively. In such embodiments, the object 106 is vertically bifurcated, with a left portion 109 of the object 106 displayed in a lower right portion of the left display 107, and a right portion 110 of the object 106 displayed in a lower left portion of the right display 108.

The simulated fixed object 106 may be integrated into the software of a game or other virtual reality simulation, or may be provided as a separate hardware or software module which is then overlayed onto the display of an existing simulation display.

Various aspects provide an improved system and method for providing a virtual reality simulation to a user. A technical effect is to improve the functioning of the simulator by reducing potential simulator sickness experienced by the user.

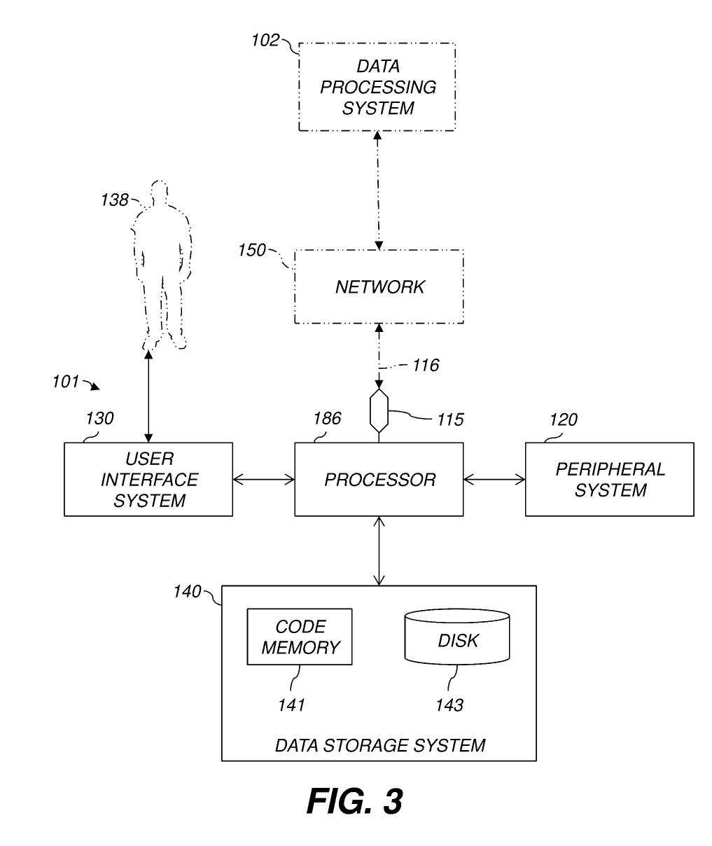

FIG. 3 is a diagram showing the components of an exemplary data-processing system 101 for providing the simulator interface 100 described herein, and related components. The system 101 includes a processor 186, a peripheral system 120, a user interface system 130, and a data storage system 140. The peripheral system 120, the user interface system 130 and the data storage system 140 are communicatively connected to the processor 186. Processor 186 can be communicatively connected to network 150 (shown in phantom), e.g., the Internet or a leased line, as discussed below. Virtual reality glasses, headsets, display screens, and other devices herein can each include one or more processor(s) 186 or one or more of systems 120, 130, 140, and can each connect to one or more network(s) 150. Processor 186, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 186 can implement processes of various aspects described herein. Processor 186 and related components can, e.g., carry out processes for providing a virtual reality simulation.

Processor 186 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise.

The phrase “communicatively connected” includes any type of connection, wired or wireless, for communicating data between devices or processors. These devices or processors can be located in physical proximity or not. For example, subsystems such as peripheral system 120, user interface system 130, and data storage system 140 are shown separately from the processor 186 but can be embodied or integrated completely or partially within the processor 186. In an example, processor 186 includes an ASIC including a central processing unit connected via an on-chip bus to one or more core(s) implementing function(s) of systems 120, 130, or 140.

The peripheral system 120 can include or be communicatively connected with one or more devices configured or otherwise adapted to provide digital content records to the processor 186 or to take action in response to signals or other instructions received from processor 186. For example, the peripheral system 120 can include digital still cameras, digital video cameras, projectors, displays, or other data processors. The processor 186, upon receipt of digital content records from a device in the peripheral system 120, can store such digital content records in the data storage system 140.

Processor 186 can, via peripheral system 120, control subsystems of a simulator. For example, processor 186 can receive and process data to provide further simulation data or displays.

The user interface system 130 can convey information in either direction, or in both directions, between a user 138 and the processor 186 or other components of system 101. The user interface system 130 can include a virtual reality glasses or headset (such as head-mount unit 104), in addition to handheld user input units 111 (as shown in FIG. 2), a mouse, a keyboard, another computer (connected, e.g., via a network or a null-modem cable), or any device or combination of devices from which data is input to the processor 186. The user interface system 130 also can include a display device, a processor-accessible memory, or any device or combination of devices to which data is output by the processor 186. The user interface system 130 and the data storage system 140 can share a processor-accessible memory.

In various aspects, processor 186 includes or is connected to communication interface 115 that is coupled via network link 116 (shown in phantom) to network 150. For example, communication interface 115 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WIFI or GSM (Global System for Mobile Communications). Communication interface 115 can send and receives electrical, electromagnetic or optical signals that carry digital or analog data streams representing various types of information across network link 116 to network 150. Network link 116 can be connected to network 150 via a switch, gateway, hub, router, or other networking device.

In various aspects, system 101 can communicate, e.g., via network 150, with other data processing system(s) (not shown), which can include the same types of components as system 101 but is not required to be identical thereto. System 101 and other systems not shown communicatively connected via the network 150. System 101 and other systems not shown can execute computer program instructions to perform simulations as described herein.

Processor 186 can send messages and receive data, including program code, through network 150, network link 116 and communication interface 115. For example, a server can store requested code for an application program (e.g., a JAVA applet) on a tangible non-volatile computer-readable storage medium to which it is connected. The server can retrieve the code from the medium and transmit it through network 150 to communication interface 115. The received code can be executed by processor 186 as it is received, or stored in data storage system 140 for later execution.

Data storage system 140 can include or be communicatively connected with one or more processor-accessible memories configured or otherwise adapted to store information. The memories can be, e.g., within a chassis or as parts of a distributed system. The phrase “processor-accessible memory” is intended to include any data storage device to or from which processor 186 can transfer data (e.g., using components of peripheral system 120). A processor-accessible memory can include one or more data storage device(s) that are volatile or nonvolatile, that are removable or fixed, or that are electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 140 can be a tangible non-transitory computer-readable storage medium, i.e., a non-transitory device or article of manufacture that participates in storing instructions that can be provided to processor 186 for execution.

In an example, data storage system 140 includes code memory 141, e.g., a RAM, and disk 143, e.g., a tangible computer-readable rotational storage device or medium such as a hard drive. In this example, computer program instructions are read into code memory 141 from disk 143. Processor 186 then executes one or more sequences of the computer program instructions loaded into code memory 141, as a result performing process steps described herein. In this way, processor 186 carries out a computer implemented process. For example, steps of methods described herein, blocks of block diagrams herein, and combinations of those, can be implemented by computer program instructions. Code memory 141 can also store data.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code (“program code”) stored on a computer readable medium, e.g., a tangible non-transitory computer storage medium or a communication medium. A computer storage medium can include tangible storage units such as volatile memory, nonvolatile memory, or other persistent or auxiliary computer storage media, removable and non-removable computer storage media implemented in any method or technology for storage of information such as computer-readable instructions, data structures, program modules, or other data. A computer storage medium can be manufactured as is conventional for such articles, e.g., by pressing a CD-ROM or electronically writing data into a Flash memory. In contrast to computer storage media, communication media may embody computer-readable instructions, data structures, program modules, or other data in a modulated data signal, such as a carrier wave or other transmission mechanism. As defined herein, “computer storage media” do not include communication media. That is, computer storage media do not include communications media consisting solely of a modulated data signal, a carrier wave, or a propagated signal, per se.

The program code can include computer program instructions that can be loaded into processor 186 (and possibly also other processors), and that, when loaded into processor 486, cause functions, acts, or operational steps of various aspects herein to be performed by processor 186 (or other processor). The program code for carrying out operations for various aspects described herein may be written in any combination of one or more programming language(s), and can be loaded from disk 143 into code memory 141 for execution. The program code may execute, e.g., entirely on processor 186, partly on processor 186 and partly on a remote computer connected to network 150, or entirely on the remote computer.

The invention is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless otherwise explicitly noted. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected within the spirit and scope of the invention.

1. A simulator system, comprising:
one or more processors;
memory operatively connected to the processors; and
a virtual reality interface module, the virtual reality interface module configured to display a simulated moving environment to a user, the interface module further configured to display a simulated fixed object in the view of the user.

2. The system of claim 1, wherein the object is displayed laterally centered in the field of view of the user.

3. The system of claim 1, wherein the fixed object is at least a portion of a simulated human nose.

4. The system of claim 3, wherein the simulated nose is displayed to simulate the user's view of the user's own nose.

5. The system of claim 1, wherein the virtual reality interface module further comprises a head mount and an electronic display.

6. The system of claim 1, wherein the display comprises a left eye display and a right eye display, and wherein the left eye display displays a left portion of the object and the right eye display displays a right portion of the object.

7. The system of claim 1, wherein the object is shaded to simulate lighting of the object.

8. The system of claim 1, wherein the object is displayed as a simulated three-dimensional object.

9. A method of simulating an environment to a user through a virtual reality interface, comprising:
providing a display of a virtual moving environment to the user, wherein the display further includes a simulated fixed object in the view of the user.

10. The method of claim 9, wherein the object is displayed laterally centered in the field of view of the user.

11. The method of claim 9, wherein the fixed object is at least a portion of a simulated human nose.

12. The method of claim 11, wherein the simulated nose is displayed to simulate the user's view of the user's own nose.

13. The method of claim 9, wherein the virtual reality interface further comprises a head mount and an electronic display.

14. The method of claim 9, wherein the display comprises a left eye display and a right eye display, and wherein the left eye display displays a left portion of the object and the right eye display displays a right portion of object.

15. The method of claim 9, wherein the object is shaded to simulate lighting of the object.

16. The method of claim 9, wherein the object is displayed as a simulated three-dimensional object.
